(19) United States
(12) Patent Application Publication
(10) Pub. No.: US 2025/0329894 A1
(43) Pub. Date: Oct. 23, 2025

(54) ALL-SOLID-STATE BATTERY

(71) Applicant: TOYOTA JIDOSHA KABUSHIKI KAISHA, Aichi-ken (JP)

(72) Inventor: Ryuto SAKAMOTO, Okazaki-shi (JP)

(21) Appl. No.: 19/077,062

(22) Filed: Mar. 12, 2025

(30) Foreign Application Priority Data
Apr. 19, 2024 (JP) 2024-068303

(51) Int. Cl. H01M 50/54; H01M 10/0585

(52) U.S. Cl. CPC H01M 50/54; H01M 10/0585

(57) ABSTRACT

The all-solid-state battery includes a stack of a plurality of battery units including a first current collector layer, an electrode layer, a second current collector layer, an electrode layer, and a first current collector layer in this order. The stacked body includes a battery unit X and a battery unit Y that are adjacent to each other, and a fixing unit that fixes the battery unit X and the battery unit Y. The fixing unit is in contact with the electrode layer of the battery unit X and the electrode layer of the battery unit Y, respectively.

### CROSS-REFERENCE TO RELATED APPLICATION

This application claims priority to Japanese Patent Application No. 2024-068303 filed on Apr. 19, 2024, incorporated herein by reference in its entirety.

### BACKGROUND

### 1. Technical Field

The present disclosure relates to an all-solid-state battery.

### 2. Description of Related Art

An all-solid-state battery that uses a solid electrolyte, instead of an electrolytic solution that is obtained by dissolving an electrolyte in an organic solvent, is being developed.

As an example of a method of manufacturing an all-solid-state battery, there is a method of stacking a plurality of battery units that are fabricated in advance. In a battery that is obtained by stacking multiple battery units, positional displacement of the battery units tends to occur, due to vibration during use, expansion and contraction during charging and discharging, and so forth. Positional displacement of the battery units can cause short-circuiting or the like. As a measure for suppressing positional displacement among battery units, Japanese Unexamined Patent Application Publication No. 2017-204377 (JP 2017-204377 A) proposes an all-solid-state battery having adhesive means for fixing adjacent battery units by an adhesive.

### SUMMARY

In the all-solid-state battery described in JP 2017-204377 A, adhesive means are provided on mutually-opposed faces of adjacent battery units. Accordingly, the number of battery units that can be accommodated in a battery case is limited due to the adhesive means disposed among the multiple battery units, and structural efficiency of the battery may be reduced.

An object of an embodiment of the present disclosure is to provide an all-solid-state battery in which positional displacement of battery units is suppressed without reducing structural efficiency of the battery.

Means for solving the above object include the following aspects.

<1> An all-solid-state battery, including
a stack of a plurality of battery units each including a first current collector layer, an electrode layer, a second current collector layer, an electrode layer, and a first current collector layer, in this order, in which
the stack includes a battery unit X and a battery unit Y that are adjacent to each other, and a fixing unit that fixes the battery unit X and the battery unit Y, and
the fixing unit is in contact with each of the electrode layers of the battery unit X and the electrode layers of the battery unit Y.

<2> The all-solid-state battery according to <1>, in which the fixing unit is in contact with each of an end face of the first current collector layer of the battery unit X and an end face of the first current collector layer of the battery unit Y.

<3> The all-solid-state battery according to <1> or <2>, in which the electrode layers of the battery unit X and the electrode layers of the battery unit Y each include a first active material layer that is adjacent to the first current collector layer, a solid electrolyte layer, and a second active material layer that is adjacent to the second current collector layer, and
the fixing unit is in contact with each of the first active material layer of the battery unit X and the first active material layer of the battery unit Y.

<4> The all-solid-state battery according to <1> or <2>, in which
the electrode layers of the battery unit X and the electrode layers of the battery unit Y each include a first active material layer that is adjacent to the first current collector layer, a solid electrolyte layer, and a second active material layer that is adjacent to the second current collector layer, and
the fixing unit is in contact with each of the solid electrolyte layer of the battery unit X and the solid electrolyte layer of the battery unit Y.

<5> The all-solid-state battery according to any one of <1> to <4>, in which the fixing unit includes resin.

According to an embodiment of the present disclosure, there is provided an all-solid-state battery in which positional displacement of battery units is suppressed without reducing structural efficiency of the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a cross-sectional view schematically showing an example of a configuration of a battery unit X and a battery unit Y adjacent to each other among battery units included in an all-solid-state battery;

FIG. 1B is a plan view schematically showing a configuration of the battery unit X shown in FIG. 1A when viewed from the main surface of the first current collector layer 10.

FIG. 2A is a cross-sectional view schematically showing an exemplary configuration of a battery unit X and a battery unit Y that are adjacent to each other among battery units included in an all-solid-state battery; and

FIG. 2B is the configuration when the battery unit X shown in FIG. 2A is observed from the main surface of the first current collector layer 10 is a plan view schematically showing.

### DETAILED DESCRIPTION OF EMBODIMENTS

The all-solid-state battery of the present disclosure includes a stack of a plurality of battery units including a first current collector layer, an electrode layer, a second current collector layer, an electrode layer, and a first current collector layer in this order.

The stacked body includes a battery unit X and a battery unit Y that are adjacent to each other, and a fixing unit that fixes the battery unit X and the battery unit Y.

The fixing unit is an all-solid-state battery in contact with the electrode layer of the battery unit X and the electrode layer of the battery unit Y, respectively.

The all-solid-state battery of the present disclosure is a so-called stacked battery including a stack of a plurality of battery units.

The stack includes a battery unit X and a battery unit Y adjacent to each other, and a fixing unit that fixes the battery unit X and the battery unit Y.

That is, at least a part of the plurality of battery units included in the stacked body is fixed by the adjacent battery unit and the fixing unit.

In the all-solid-state battery of the present disclosure, the fixing unit is in contact with the electrode layer of the battery unit X and the electrode layer of the battery unit Y, respectively. That is, it is different from an existing all-solid-state battery in that a place where the fixing unit is disposed is not between the first electrode layer of the battery unit X and the first electrode layer of the battery unit Y.

In the all-solid-state battery of the present disclosure, the influence of the thickness of the fixing unit in the dimension of the battery unit in the stacking direction is reduced as compared with the case where the fixing unit is disposed between the first electrode layer of the battery unit X and the first electrode layer of the battery unit Y. As a result, the number of battery units that can be accommodated in the battery case is sufficiently secured, and a decrease in the structural efficiency of the battery is suppressed.

In the following description, the battery unit X and the battery unit Y may be referred to as “battery units” without being distinguished from each other.

The battery unit constituting the stack includes a first current collector layer, an electrode layer, a second current collector layer, an electrode layer, and a first current collector layer in this order.

The first current collector layer and the second current collector layer are opposite to each other. That is, the second current collector layer in the case where the first current collector layer is the negative electrode current collector layer is the positive electrode current collector layer, and the second current collector layer in the case where the first current collector layer is the positive electrode current collector layer is the negative electrode current collector layer.

From the viewpoint of more reliably suppressing the positional displacement of the battery unit, the fixing unit for fixing the battery unit X and the battery unit Y is preferably in contact with the end face of the first current collector layer of the battery unit X and the end face of the first current collector layer of the battery unit Y, respectively.

From the viewpoint of effectively suppressing a decrease in the structural efficiency of the all-solid-state battery, it is preferable that the fixing unit is disposed at a portion that is inside the outer periphery of the stacked body when the stacked body of the battery units is observed from the upper surface in the stacking direction.

Among the plurality of battery units included in the stack, all of the battery units may satisfy the conditions of the battery unit X and the battery unit Y, or some of the battery units may satisfy the conditions of the battery unit X and the battery unit Y.

That is, all of the plurality of battery units included in the stacked body may be fixed by the adjacent battery unit and the fixing unit, or some of the battery units may be fixed by the adjacent battery unit and the fixing unit.

From the viewpoint of effectively suppressing the positional displacement of the battery unit, it is preferable that 50% to 100% of the plurality of battery units included in the stack satisfy the conditions of the battery unit X and the battery unit Y on a number basis. It is preferable that 70% to 100% of the plurality of battery units included in the stack satisfy the conditions of the battery unit X and the battery unit Y on a number basis. It is further preferable that 80% to 100% of the plurality of battery units included in the stack satisfy the conditions of the battery unit X and the battery unit Y on a number basis.

The electrode layer included in the battery unit may include a first active material layer adjacent to the first current collector layer, a solid electrolyte layer, and a second active material layer adjacent to the second current collector layer.

The first active material layer in the case where the first current collector layer is a negative electrode current collector layer is a layer containing a negative electrode active material, and the first active material layer in the case where the first current collector layer is a positive electrode current collector layer is a layer containing a positive electrode active material.

The second active material layer in the case where the second current collector layer is a negative electrode current collector layer is a layer containing a negative electrode active 25 material, and the second active material layer in the case where the second current collector layer is a positive electrode current collector layer is a layer containing a positive electrode active material.

Hereinafter, the first active material layer and the second active material layer may be referred to as an “active material layer” without being distinguished from each other.

The active material layer is a layer including at least an active material, and the solid electrolyte layer is a layer including at least a solid electrolyte. The active material layer may include a solid electrolyte together with the active material.

The fixing unit for fixing the battery unit X and the battery unit Y may be in contact with any layer included in the electrode layer. For example, the following aspects 1 to 3 are exemplified. In Aspects 1 to 3, the fixing unit may be further in contact with another layer included in the electrode layer.

Embodiment 1: An embodiment in which the fixing unit is in contact with the 1 active material layer of the battery unit X and the 1 active material layer of the battery unit Y, respectively

Embodiment 2: An embodiment in which the fixing unit is in contact with the 1 active material layer of the battery unit X and the 1 active material layer of the battery unit Y, respectively

Embodiment 3: An embodiment in which the fixing unit is in contact with the 2 active material layer of the battery unit X and the 2 active material layer of the battery unit Y, respectively

The material of the fixing unit is not particularly limited as long as the battery unit X and the battery unit Y can be fixed.

From the viewpoint of more securely fixing the battery unit X and the battery unit Y, the fixing unit is preferably in a state of being adhered to the electrode layer of the battery unit X and the electrode layer of the battery unit Y.

Examples of the fixing unit in a state of being adhered to the electrode layer of the battery unit X and the electrode layer of the battery unit Y include a fixing unit containing a resin. The fixing unit containing resin is formed, for example, by applying a material containing resin such as a solution obtained by dissolving a hot melt adhesive and a binder in a solvent to a predetermined portion of at least one of the electrode layer of the battery unit X and the electrode layer of the battery unit Y.

When the fixing unit includes a resin, the type of the resin is not particularly limited. Specific examples of the resin include polyolefins such as polyethylene (PE) and polypropylene (PP), ethylene-vinyl acetate copolymers (EVA), styrene-isoprene-styrene block copolymers (SIS), polyvinylidene fluoride (PVDF), carboxymethylcellulose (CMC), styrene-butadiene rubber (SBR), acrylic resins, polyurethanes, polyesters, and polyamides.

The method of applying the material of the fixing unit to the electrode layer of the battery unit is not particularly limited, and may be selected from known methods such as coating, printing, transfer, and inkjet.

If necessary, the material of the fixing unit may be applied to the electrode layer of the battery unit, and then treatment such as heating and pressurization may be performed.

From the viewpoint of more reliably suppressing the positional displacement of the battery unit, the portion to which the material of the fixing unit is applied is preferably a portion adjacent to the end face of the first current collector layer disposed on the electrode layer to which the material of the fixing unit is applied.

From the viewpoint of effectively suppressing a decrease in the structural efficiency of the all-solid-state battery, it is preferable that the portion to which the material of the fixing unit is applied is a portion which is located inside the outer periphery of the battery unit when the battery unit is observed from the upper surface in the stacking direction.

Hereinafter, an example of a configuration of an all-solid-state battery of the present disclosure will be described with reference to the drawings. The dimensions and shapes of the respective members shown in the following drawings are conceptual, and the actual configuration is not limited thereto.

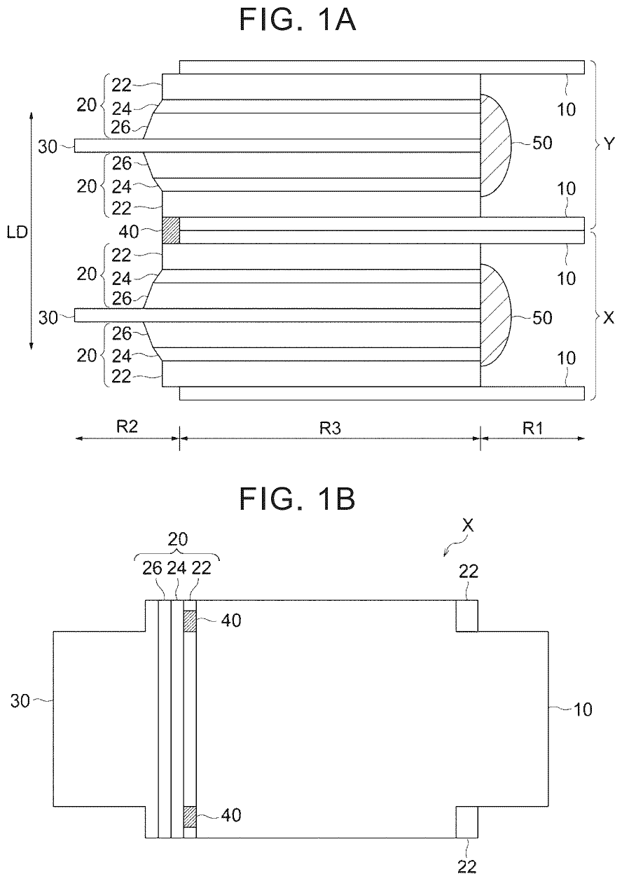

FIG. 1A is a cross-sectional view schematically showing an of a configuration of a battery unit X and a battery unit Y that are adjacent to each other, out of battery units included in the all-solid-state battery according to the present disclosure.

The battery unit X and the battery unit Y shown in FIG. 1A are formed by laminating the first current collector layer 10, the electrode layer 20, the second current collector layer 30, the electrode layer 20, and the first current collector layer 10 in this order. Electrode layers 20 are disposed on both sides of the first current collector layer 10. Each of the electrode layers 20 is in a state in which the first active material layer 22 adjacent to the first current collector layer 10, the solid electrolyte layer 24, and the second active material layer 26 adjacent to the second current collector layer 30 are stacked in this order.

As shown in FIG. 1A, the first current collector layer 10 and the second current collector layer 20 included in the battery unit X and the battery unit Y protrude differently from each other.

In FIG. 1A, a region in which the first current collector layer protrudes is referred to as a first protruding region R1, a region in which the second current collector layer protrudes is referred to as a second protruding region R2, and a region between the first protruding region R1 and the second protruding region R2 is referred to as an intermediate region R3.

In the first protruding region R1 and the second protruding region R2, the first current collector layer 10 does not overlap the second current collector layer 30 in the stacking-direction LD.

As shown in FIG. 1A, the second current collector layers 30 included in the battery unit X and the battery unit Y are covered with the insulating portion 50 on the end surface thereof on the first protruding region R1 side. The insulating portion 50 suppresses the second current collector layer 30 from contacting (short-circuiting) the first current collector layer 10.

As shown in FIG. 1A, the battery unit X and the battery unit Y have parts (hereinafter, also referred to as clearances) in which the electrode layer 20 and the first current collector layer 10 do not overlap each other in the stacking-direction LD. The fixing unit 40 is disposed in the clearance between the battery unit X and the battery unit Y, and is in contact with the electrode layer 20 of the battery unit X (the first active material layer 22 in 1A of the drawing) and the electrode layer 20 of the battery unit Y (the first active material layer 22 in FIG. 1A).

The fixing unit 40 shown in FIG. 1A is disposed near the border between the intermediate region R3 and the second protruding region R2.

FIG. 1B is a plan view schematically showing the configuration of the battery unit X shown in FIG. 1A when viewed from the main surface of the first current collector layer 10.

As shown in FIG. 1B, the first current collector layers 10 of the battery unit X have a configuration in which a part corresponding to the first protruding region R1 protrudes. The fixing unit 40 is disposed in a portion (clearance) where the first active material layer 22 included in the electrode layer 20 is exposed. The clearance is provided on the side having the protruding portion of the first current collector layer 10 and the side opposite to the side having the protruding portion of the first current collector layer 10, respectively.

The fixing unit 40 shown in FIG. 1B is disposed at a clearance opposite to the side having the protruding part of the first current collector layer 10.

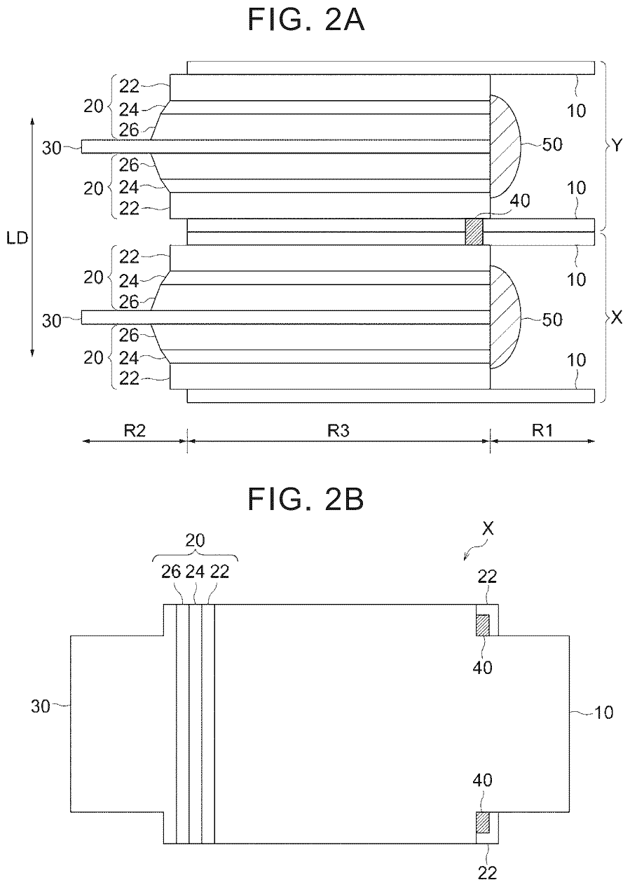

FIG. 2A is a cross-sectional view schematically showing an of a configuration of a battery unit X and a battery unit Y that are adjacent to each other, out of battery units included in the all-solid-state battery according to the present disclosure.

In the configuration shown in FIG. 2A, unlike the configuration in which the fixing unit 40 is disposed near the boundary between the intermediate region R3 and the second protruding region R2 of the battery unit (see FIG. 1A), the fixing unit 40 is disposed near the boundary between the intermediate region R2 and the first protruding region R1 of the battery unit.

FIG. 2B is a plan view schematically showing the configuration of the battery unit X shown in FIG. 2A when viewed from the main surface of the first current collector layer 10.

In the configuration shown in the FIG. 2B, unlike the configuration in which the fixing unit 40 is disposed in the clearance opposite to the side having the protruding portion of the first current collector layer 10 (see FIG. 1B), the fixing unit 40 is disposed in the clearance on the side having the protruding portion of the first current collector layer 10.

In the above-described drawings, the fixing unit 40 is in contact with the first active material layer 22 included in the electrode layer 20 of the battery unit X and the battery unit Y, but the embodiment of the present disclosure is not limited thereto. For example, the fixing unit 40 may be in contact with the solid electrolyte layer 24 or the second active material layer 26 included in the electrode layer 20 of the battery unit X and the battery unit Y in the fixing unit 40.

In the above-described drawings, the number of the fixing units 40 included in the battery unit X and the battery unit Y is two per one battery unit, but the embodiment of the present disclosure is not limited thereto. For example, the number of the fixing unit 40 per one battery unit may be three or more even one.

As illustrated in the above-described drawings, the fixing unit 40 may be disposed on a side where the first current collector layer of the battery unit does not protrude (see FIG. 1A and FIG. 1B), or may be disposed on a side where the first current collector layer of the battery unit protrudes (see FIG. 12 and FIG. 2B).

From the viewpoint of suppressing positional displacement of the battery unit while suppressing occurrence of a short circuit due to expansion and contraction of the battery unit, it is preferable that the fixing unit is disposed on a side of the battery unit where the first current collector layer does not protrude.

The amount of change in size due to expansion of the battery unit is proportional to the size of the battery unit starting from the position where the fixing unit is disposed. Therefore, the positional displacement caused by the expansion of the battery unit is more likely to occur on the side where the fixing unit of the battery unit is not disposed.

In the configurations illustrated in FIG. 1A and FIG. 1B, the degree of expansion of the battery unit on the side where the fixing unit is not disposed (that is, the side where the second current collector layers protrude) is relatively large. On the other hand, the end face on the side where the second current collector layer does not protrude can be subjected to an insulating treatment such as coating with an insulating portion at the time of manufacturing the battery unit. Therefore, even if expansion of the battery unit occurs on the side where the second current collector layer protrudes, the risk of a short circuit is easily reduced.

Hereinafter, components of the battery unit included in the all-solid-state battery of the present disclosure will be described. However, the all-solid-state battery of the present disclosure is not limited thereto.

The battery unit includes a first current collector layer, an electrode layer, a second current collector layer, an electrode layer, and a first current collector layer in this order.

The second current collector layer in the case where the first current collector layer is a negative electrode current collector layer is a positive electrode current collector layer, and the second current collector layer in the case where the first current collector layer is a positive electrode current collector layer is a negative electrode current collector layer.

Examples of the material of the negative electrode current collector layer or the positive electrode current collector layer include metals of Ag, Cu, Au, Al, Ni, Fe, Ti or alloys containing these metals.

The material of the negative electrode current collector layer is preferably Cu or Ni, and the material of the positive electrode current collector layer is preferably Al.

The electrode layer included in the battery unit includes a first active material layer adjacent to the first current collector layer, a solid electrolyte layer, and a second active material layer adjacent to the second current collector layer.

The first active material layer in the case where the first current collector layer is a negative electrode current collector layer is a layer containing a negative electrode active material, and the first active material layer in the case where the first current collector layer is a positive electrode current collector layer is a layer containing a positive electrode active material.

The second active material layer in the case where the second current collector layer is a negative electrode current collector layer is a layer containing a negative electrode active material, and the second active material layer in the case where the second current collector layer is a positive electrode current collector layer is a layer containing a positive electrode active material.

The negative electrode active material may be selected from materials capable of occluding and releasing metal ions such as lithium ions.

Specific examples of the negative electrode active material include metallic lithium, lithium alloys, carbon materials such as graphite and hard carbon, metallic alloys, silicon materials such as silicon alloys, and Li₄Ti₅O₁₂ (LTO).

Specific examples of the positive electrode active material include transition metals such as manganese, cobalt, nickel, and titanium, and metal oxides containing lithium. Specific examples thereof include lithium cobaltate, lithium nickelate, lithium manganate, lithium nickel cobalt manganate, a hetero-element substituted Li—Mn spinel, lithium titanate, and metallic lithium phosphate.

Examples of the solid electrolyte include a sulfide-based amorphous solid electrolyte, an oxide-based amorphous solid electrolyte, a sulfide-based crystalline solid electrolyte, an oxide-based crystalline solid electrolyte, an iodide-based crystalline solid electrolyte, a nitride-based solid electrolyte, and the like.

If necessary, each layer constituting the electrode layer may contain a component other than an active material or a solid electrolyte. Examples of the component other than the active material or the solid electrolyte include a binder and a conductive material.

The thickness of the stack composed of a plurality of battery units is not particularly limited, and can be set according to the application and performance of the all-solid-state battery.

For example, the thickness of the stack can be selected from 1 mm to 100 mm.

The stacked body including the plurality of battery units may be accommodated in the exterior body. The material of the exterior material for accommodating the stack is not particularly limited, and can be set according to the use and performance of the all-solid-state battery. In some embodiments, the exterior body may be one including a substrate layer and a barrier layer (laminate film).

The material of the base layer is not particularly limited, and examples thereof include a thermoplastic resin and a metal. Examples of the barrier layer include a metal foil and a vapor-deposited layer.

The number of battery units included in the stack is not particularly limited, and can be selected according to the size, performance, and the like of all the all-solid-state battery.

For example, the number of battery units included in the stack may be selected from a range of 10 to 100.

The thickness of the all-solid-state battery including the stack of the battery units is not particularly limited, and can be set according to the application and performance of the all-solid-state battery.

For example, the thickness of the all-solid-state battery can be selected from 1 mm to 100 mm.

What is claimed is:

1. An all-solid-state battery, comprising:
a stack of a plurality of battery units each including a first current collector layer, an electrode layer, a second current collector layer, an electrode layer, and a first current collector layer, in this order, wherein
the stack includes a battery unit X and a battery unit Y that are adjacent to each other, and a fixing unit that fixes the battery unit X and the battery unit Y, and
the fixing unit is in contact with each of the electrode layers of the battery unit X and the electrode layers of the battery unit Y.

2. The all-solid-state battery according to claim 1, wherein the fixing unit is in contact with each of an end face of the first current collector layer of the battery unit X and an end face of the first current collector layer of the battery unit Y.

3. The all-solid-state battery according to claim 1, wherein:
the electrode layers of the battery unit X and the electrode layers of the battery unit Y each include a first active material layer that is adjacent to the first current collector layer, a solid electrolyte layer; and a second active material layer that is adjacent to the second current collector layer; and
the fixing unit is in contact with each of the first active material layer of the battery unit X and the first active material layer of the battery unit Y.

4. The all-solid-state battery according to claim 1, wherein:
the electrode layers of the battery unit X and the electrode layers of the battery unit Y each include a first active material layer that is adjacent to the first current collector layer, a solid electrolyte layer, and a second active material layer that is adjacent to the second current collector layer; and
the fixing unit is in contact with each of the solid electrolyte layer of the battery unit X and the solid electrolyte layer of the battery unit Y.

5. The all-solid-state battery according to claim 1, wherein the fixing unit includes resin.
